(19) United States
(12) Patent Application Publication
(10) Pub. No.: US 2020/0191211 A1
(43) Pub. Date: Jun. 18, 2020

(54) CALIPER HOUSING

(71) Applicant: Akebono Brake Industry Co., Ltd., Tokyo (JP)

(72) Inventor: Michio Suzuki, Walled Lake, MI (US)

(21) Appl. No.: 16/224,122

(22) Filed: Dec. 18, 2018

(51) Int. Cl. F16D 65/00; F16D 55/228

(52) U.S. Cl. CPC F16D 65/0075; F16D 2055/002; F16D 55/228; F16D 65/0087

(57) ABSTRACT

The disclosure relates to a caliper housing and method of assembling the caliper housing. The caliper housing includes a) a caliper body having: i) an inboard side having one or more openings; ii) an outboard side distanced from the inboard side so that a rotor gap is formed between the inboard side and the outboard side; iii) a bridge structure which extends from both the inboard side and the outboard side over the rotor gap and connects the inboard side with the outboard side; and b) one or more cylinder bodies which are hollow, extend through the one or more openings, and are engaged such that the one or more cylinder bodies are non-moveable relative to the one or more openings.

### FIELD

The present teachings generally relate to a caliper. The caliper includes a caliper housing having a cylinder body removably affixed to a one-piece caliper body. The cylinder body may be particularly useful in allowing for assembly of piston components prior to insertion into the caliper housing.

### BACKGROUND

Disc brakes are widely used for braking applications in automobiles. A disc brake generally includes a caliper and a rotor. The rotor may be connected to a wheel and/or axle, so the rotor rotates with the wheel. Styles of calipers may include floating or fixed calipers. Floating calipers generally include one or more pistons on one side of a rotor while a fixed caliper (e.g., opposing piston caliper) includes opposing pistons facing toward a rotor. The housing of a caliper is typically constructed as a monoblock housing (e.g., one-piece) or a multi-piece (e.g., two-piece) housing.

A multi-piece housing may be advantageous as the separate pieces allow interior components of a caliper to be assembled before an outboard side of the caliper housing is assembled to an opposing inboard side of the caliper housing. These interior components may include a linear motion mechanism, piston, pressure plates, friction material, and the like. Multi-piece housings may also present problems with vibrations, brake squeal, and brake efficiency. When a brake force is created, a reaction force opposite the brake force is also created. Some of this reaction force results in displacing the outboard side relative to the inboard side, or vice versa, such that the caliper housing is spread apart. This deflection may lead to increased pedal travel and tapered brake pad wear. This displacement may also result in vibrations of the caliper. These vibrations may produce a low frequency brake squeal heard within an interior of a vehicle. Additionally, when the brake force is created, the friction generated between the rotor and the brake pads may generate an intense heating of the rotor. If the resulting heat is not sufficiently dissipated, the heat may melt the brake pads and/or the heat may transfer through the pistons to overheat, and even boil, the brake fluid.

A monoblock caliper housing resolves some of the challenges presented by the two-piece design. The monoblock caliper housing includes an outboard side integrally attached to an opposing inboard side via a bridge structure. As the outboard side is integrally affixed to the inboard side, displacement of one relative to the other is relatively reduced. Additionally, reinforcement structures may be utilized to help strengthen the bridge structure and further reduce the deflection. Monoblock caliper housings may also present their own challenges due to their one-piece design. Typically, the interior brake components are inserted through a rotor gap between the outboard and inboard side. This rotor gap has a fixed width, thus limiting visibility and tooling access during assembly. One particular challenge during assembly is assembly of an internal linear motion mechanism and piston located within a cylinder body. The cylinder body may project outward from the inboard side, outboard side, or both and away from the rotor gap. The interior of the cylinder body is generally accessible through an opening formed in the inboard or outboard side and in communication with the rotor gap. Thus, during manufacturing, the components of the linear motion mechanism and piston are first inserted through the rotor gap, through the opening, and then into the cylinder body, and thereafter secured into place.

It would be advantageous to provide for a caliper housing in which the inboard side is integrally affixed to the outboard side with a bridge structure, but yet allows for easier access to install interior components. It would be advantageous to provide for a cylinder body which is removably affixed to a housing body to allow for sub-assembly of piston components prior to installation to the caliper housing. It would be advantageous to provide for a cylinder body which is removably affixed to a housing body to allow for easier access during repair. It would be advantageous to include a reinforcement structure as part of the bridge structure which is able to provide structural rigidity to the caliper housing, thus reducing or preventing displacement of an outboard side relative to an inboard side. It is also desirable to include sufficient openings in the bridge structure to allow for heat dissipation when a brake force is created but do not interfere with a reinforcing structure to provide sufficient structural integrity to the caliper housing.

### SUMMARY

The present disclosure relates to a caliper housing comprising: a) a caliper body including: i) an inboard side having one or more openings; ii) an outboard side distanced from the inboard side so that a rotor gap is formed between the inboard side and the outboard side; iii) a bridge structure which extends from both the inboard side and the outboard side over the rotor gap and connects the inboard side with the outboard side; and b) one or more cylinder bodies which are hollow, extend through the one or more openings, and are engaged such that the one or more cylinder bodies are non-moveable relative to the one or more openings.

The present disclosure relates to a caliper comprising: a) a caliper housing including: i) a caliper body having: an inboard side having one or more openings; an outboard side distanced from the inboard side so that a rotor gap is formed between the inboard side and the outboard side; a bridge structure which extends from both the inboard side and the outboard side over the rotor gap and connects the inboard side with the outboard side; and ii) one or more cylinder bodies which are hollow, extend through the one or more openings, and are engaged such that the one or more cylinder bodies are non-moveable relative to the one or more openings; and b) one or more pistons residing within the one or more cylinder bodies adapted to move toward and away from the rotor gap to apply and release a brake force.

The present disclosure further relates to a method of assembling a caliper housing comprising: a) inserting one or more cylinder bodies into a rotor gap of a caliper body, wherein the rotor gap is defined as a distance between an inboard side and an outboard side of the caliper body and are integrally connected via a bridge which extends over the rotor gap; b) press-fitting the one or more cylinder bodies into one or more openings formed in the inboard side of the caliper body such that a flange of the one or more cylinder bodies abuts with an inward facing surface of the inboard side which faces toward the rotor gap; and c) securing the one or more cylinder bodies to the caliper body with one or more fasteners.

The present disclosure provides for a caliper body which includes a bridge structure integrally affixed to both an inboard side and an outboard side, thus providing for the advantages of a monoblock design. The caliper body is part of a caliper housing in which one or more cylinder bodies may be removably engaged with the caliper body. The cylinder body may be beneficial as piston components, such as a piston and linear motion mechanism, may be sub-assembled into the cylinder body before the cylinder body is assembled to the caliper body. By preassembling the piston components before being installed to the caliper body, there may be ease of access and visibility for an operator, tooling, or both. Additionally, during repair procedures, the piston subassembly may be easily removable to more easily identify and perform necessary repairs. The bridge structure may include one or more through-holes to provide for a lighter weight housing. A combination of the reinforcing structure with one or more through-holes may also allow for heat dissipation of heat generated from the rotor and pad surfaces into surrounding air.

### BRIEF DESCRIPTION OF DRAWINGS

FIG. 1 is a perspective view of a caliper according to the teachings herein.

FIG. 2 is a front elevation view of a caliper according to the teachings herein.

FIG. 3 is a perspective view of a caliper body according to the teachings herein.

FIG. 4 is a bottom elevation view of a caliper housing according to the teachings herein.

FIG. 5 illustrates a cross-section of a caliper taken along section A-A of FIG. 2 according to the teachings herein.

FIG. 6 illustrates a cross-section of a caliper housing taken along section A-A of FIG. 2 according to the teachings herein.

FIG. 7 is a perspective view of a caliper housing according to the teachings herein.

FIG. 8 is a partial cross-section view of a caliper housing according to the teachings herein.

FIG. 9 illustrates a cross-section of a caliper housing taken along section A-A of FIG. 2 according to the teachings herein.

FIG. 10 is a perspective view of a caliper housing according to the teachings herein.

FIG. 11 is a front elevation view of a brake assembly including the caliper housing according to the teachings herein.

### DETAILED DESCRIPTION

The present teachings meet one or more of the above needs by the improved devices and methods described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present disclosure generally provides a brake assembly and caliper for use with vehicles. The brake assembly and caliper may be used with almost any vehicle. A vehicle may include a car, truck, bus, train, airplane, motorcycle, or the like. Alternatively, the brake assembly and/or the caliper may be integrated into components used for manufacturing or other equipment requiring a brake. Components may include a lathe, winder for paper products or cloth, amusement park rides, turbines, wind turbines, or the like. However, the present disclosure may be found particularly suitable for use with passenger vehicles. Passenger vehicles may include a car, truck, sports utility vehicle, or the like. A brake assembly may be understood as a disc brake, hydraulic brake, electronic brake, electromechanical brake, the like, or any combination thereof. The present disclosure may find particular use in a disc brake assembly. A disc brake assembly may include a floating caliper, fixed caliper, or both.

Generally, a brake assembly includes a rotor and a caliper. The caliper includes a caliper housing containing an inboard friction material and an outboard friction material on opposing sides of the rotor. The friction material may be part of a brake pad. The caliper housing may include at least one cylinder body in which at least one piston may be housed. The piston may be moved by a brake fluid or may be mechanically moved, such as by a linear motion mechanism. The piston may be moved during a brake apply toward and/or into contact with the friction material, during a brake release away from the friction material, or both. During a brake apply, the friction material may then be moved into contact with a rotor so that a brake force is created.

The brake assembly may include a rotor. The rotor may slow down or stop rotation of a wheel and/or axle. The rotor may have a general disc shape. The rotor includes one or more surfaces which receive a brake force. The rotor includes opposing braking surfaces. The opposing braking surfaces may include an inner surface and an outer surface. The rotor may define a rotational axis.

The rotor may rotate about a rotational axis. The rotational axis may function to allow the rotor to rotate co-axially with a wheel and/or axle. The rotational axis may be co-axial with a rotational axis of a vehicle wheel and/or axle. The rotational axis may be generally parallel, perpendicular, or any angle therebetween relative to one or more inward facing surfaces of one or more bodies, one or more inward facing surfaces of one or more gap plates, cross-sections of one or more openings, opposing surfaces of the rotor, one or more planes of a caliper housing, actuation movement of one or more pistons, one or more axes of one or more cylinder bodies, or any combination thereof. For example, the rotational axis may be generally perpendicular to opposing surfaces of the rotor, cross-sections of one or more openings, one or more inward facing surfaces of one or more caliper bodies, a transverse plane, or a combination thereof. The rotational axis may be generally parallel with one or more axes of one or more cylinder bodies, actuation movement of one or more pistons, recesses, gap plates, or any combination thereof.

A rotational axis may define a radial direction. The radial direction may function to define structural relationships of one or more portions of the caliper housing, brake assembly, or both. The radial direction may be generally parallel, perpendicular, or any angle therebetween relative to a rotational axis, one or more inward facing surfaces of one or more caliper bodies, opposing surfaces of the rotor, one or more planes, or any combination thereof. The radial direction may be generally perpendicular to the rotational axis of the rotor. The radial direction may be generally parallel with one or more inward facing surfaces of one or more caliper bodies, opposing surfaces of the rotor, cross-sections of one or more openings, or a combination thereof. The radial direction may define a radial outward direction. A radial outward direction may be defined as a direction which follows away from the rotational axis of the rotor. The radial outward direction may follow away from the rotational axis in the radial direction. One or more portions of a caliper housing may be located radially outward from the rotational axis.

The present teachings relate to a caliper housing. The caliper housing may function to house one or more braking components. Exemplary braking components may include one or pistons, brake pads (i.e., pressure plates, friction material), a rotor, brake fluid, linear motion mechanisms, or any combination thereof. The caliper housing may be a unitary housing (e.g., one-piece, monoblock) or a multi-piece housing. The caliper housing may include one or more bodies, one or more bridge structures, one or more reinforcing structures, one or more through-holes, one or more fasteners, one or more fastener bores, a rotor gap, or any combination thereof. One or more bodies may be located on opposing sides of a rotor gap, a rotor, or both. The caliper housing may have opposing sides. The opposing sides may be sides of a caliper housing where one or more bodies mate with one or more other bodies. The caliper housing may have an outer periphery. The outer periphery may be defined by one or more exterior surfaces of the caliper housing. An outer periphery of the caliper housing, taken along a cross-section, may have a general geometric shape. The cross-section shape of the outer periphery may be generally ovular, elliptical, circular, triangular, square, rectangular, trapezoidal, the like, or any combination thereof. The cross-section of the outer periphery may be taken along one or more planes of the caliper housing. The one or more planes may include a longitudinal plane, transverse plane, or a plane parallel and/or perpendicular with either the longitudinal plane or transverse plane. For example, the outer periphery of the caliper housing may have a generally trapezoid-like shape at a cross-section taken along a plane perpendicular with both the transverse and longitudinal planes of the caliper housing.

The caliper housing may define one or more planes. The one or more planes may function to describe the location of one or more portions of the caliper, brake assembly, or both relative to one or more other portions. One or more planes may include a longitudinal plane; a transverse plane; one or more planes perpendicular, parallel, or any angle therebetween relative to the longitudinal plane and/or transverse plane; or any combination thereof. One or more planes may be parallel, perpendicular, or any angle therebetween relative to one or more inward facing surfaces of one or more bodies, one or more inward facing surfaces of one or more gap plates, opposing surfaces of a rotor, a rotational axis, an axis of one or more pistons, or any combination thereof. A longitudinal plane may intersect and/or be generally perpendicular with one or more bodies, inward facing surfaces of one or more bodies, a rotor, opposing surfaces of a rotor, a rotor gap, or any combination thereof. The longitudinal plane may be parallel with a rotational axis, an axis of one or more pistons, or both. A transverse plane may be substantially perpendicular with one or more other planes. A transverse plane may be substantially perpendicular with the longitudinal plane. A transverse plane may be substantially parallel with one or more inward facing surfaces of one or more bodies, opposing surfaces of a rotor, or both. A transverse plane may lie within the rotor gap. A transverse plane may lie within a rotor between opposing surfaces, without passing through the opposing surfaces.

The caliper housing includes one or more caliper bodies. One or more caliper bodies may include a single body (e.g. monoblock) or a plurality of connected bodies (multi-piece). The one or more caliper bodies may function to mount the caliper housing, partially enclose a rotor, retain a linear motion mechanism, seal in a fluid, retain one or more pressure pads, retain one or more bushings, or any combination thereof. The one or more caliper bodies may have any size, shape, and or configuration to allow assembly of one or more cylinder bodies through a rotor gap, allow one or more pistons to be actuated toward a rotor to create a brake force, allow one or more pressure pads to remain fixed while one or more pressure pads move toward and/or away from a rotor, allow opposing pressure pads to move toward and/or away from a rotor, or any combination thereof. The one or more caliper bodies may be located adjacent and/or opposing one or more surfaces of a rotor. The one or more caliper bodies may include two or more sides. The sides may be opposing one another. The sides may be located opposite each other relative to a transverse plane. The one or more caliper bodies may include an inboard side opposing an outboard side. An inboard side may be located adjacent and opposing an inner surface of a rotor. An outboard side may be located adjacent and opposing an outer surface of a rotor. An inboard side may be attached to or integral with an outboard side. An inboard side may be integral with an outboard side to form a monoblock caliper body. An inboard side may be integrally attached to an outboard side via a bridge structure. The one or more caliper bodies may be generally symmetric or asymmetric. Symmetry may be measured about one or more planes. A caliper body may be asymmetric to provide a light weight caliper housing. For example, an outboard side may have a smaller cross-sectional area than an inboard side. The cross-sectional area may be taken along one or more planes perpendicular to both a transverse plane and a longitudinal plane. The one or more caliper bodies may include opposing ends. The opposing ends may include a trailing end, a leading end, or both. A trailing end of the caliper body may be the end closest to a brake pad which first comes into contact with the rotor as it turns. One or more caliper bodies may include one or more openings, fastener openings, recesses, gap plates, rotor gaps, bridge structures, through-holes, inward facing surfaces (e.g., interior surface), outward facing surfaces (e.g., exterior surface), or any combination thereof. One or more inward facing surfaces may be defined as surfaces facing toward a rotor gap, rotor, brake pad, or any combination thereof. One or more inward facing surfaces may be opposing one or more other inward facing surfaces. For example, an inward facing surface of an inboard side may be distanced from and opposing an inward facing surface of an outboard side with a rotor gap therebetween. Exemplary caliper bodies may be or include features of those disclosed in U.S. Pat. Nos. 7,766,132; 9,291,224 and 9,989,112; and US Patent Publication Nos.: 2017-0370453 and 2018-0187730; incorporated herein by reference in its entirety for all purposes.

One or more caliper bodies may include a rotor gap. The rotor gap may function to house a rotor. The rotor gap may be formed by a distance between opposing surfaces of a caliper housing. Opposing surfaces may include inward facing surfaces which are opposing one another. The rotor gap may have a width suitable for insertion therethrough of one or more cylinder bodies, pistons, linear motion mechanisms, or a combination thereof. The width may be measured as the distance from one inward facing surface to an opposing inward facing surface. The inward facing surfaces may include that of an outboard side, inboard side, gap plate, or a combination thereof. The rotor gap may have a fixed or a variable width. A variable width may facilitate easier insertion of one or more cylinder bodies, pistons, linear motion mechanisms, or a combination thereof having a length longer than the width of the rotor gap if it were fixed. A variable width may facilitate providing a larger rotor gap for assembly of one or more cylinder bodies while also allowing for use of less packaging space for operation of a brake assembly. The rotor gap may have a width less than, about equal to, or greater than a length of one or more cylinder bodies, pistons, linear motion mechanisms, or a combination thereof. A cylinder body may be inserted at an angle to pass through an opening of the caliper. The angle may be parallel, perpendicular, or any angle therebetween. The angle of insertion may be a longitudinal axis of the cylinder body relative to a rotational axis of a rotor, longitudinal axis of an opening, or both. The angle of insertion may allow for the width of the rotor gap to be smaller than a length of the cylinder body. A width of a rotor gap may be measured before or after insertion of a gap plate. A width of a rotor gap may or may not incorporate a length of a recess. A rotor gap may have a width of about 10 mm or greater, about 15 mm or greater, about 25 mm or greater, or even about 35 mm or greater. A rotor gap may have a width of about 80 mm or less, about 70 mm or less, about 60 mm or less, or even about 50 mm or less. A bridge structure may be located radially outward from the rotor gap. The rotor gap may be in communication with an external environment via one or more portions of the bridge structure. One or more portions of the bridge structure may include one or more through-holes. One or more openings, recesses, or both of the caliper body may be in communication with the rotor gap. One or more openings which receive and/or engage with one or more cylinder bodies may be in communication with the rotor gap.

The one or more caliper bodies may include one or more recesses. The one or more recesses may function to increase a width of a rotor gap, allow one or more cylinder bodies to fit within a rotor gap during assembly to a caliper body, or both. The one or more recesses may be located on any portion of a caliper body suitable for increasing a width of a rotor gap, allow for insertion of a cylinder body, or both. The one or more recesses may be formed in one or more bodies. The one or more recesses may be formed in one or more inward facing surfaces. The one or more inward facing surfaces may be located opposite one or more cylinder bodies, openings, or both. The one or more recesses may extend partially or completely through one or more caliper bodies. The one or more recesses may extend partially into a caliper body. The one or more recesses may extend partially from an inward facing surface of a caliper body toward an exterior facing surface. For example, one or more recesses may extend from an inward facing surface of an outboard side partially toward the exterior facing surface. The one or more recesses may extend partially or completely from an exterior facing surface toward a bridge structure. The one or more exterior facing surfaces may include an exterior facing surface substantially opposite of a bridge structure. For example, the one or more recesses may extend partially from an exterior facing surface of the outboard side toward the bridge structure. The one or more recesses may have any suitable shape for, at least temporarily, expanding a width of a rotor gap, allowing insertion of one of more cylinder bodies in the rotor gap, or both. The one or more recesses may have a shape which is substantially cylindrical, spherical, conical, cubical, cuboidal, prismed, the like, or a combination thereof. The one or more recesses may be formed as a bore, channel, slot, cut-out, notch, indentation, groove, the like, or a combination thereof. The one or more recesses may have a shape which partially or completely reciprocal with one or more gap plates, cylinder bodies, pistons, or a combination thereof. For example, one or more recesses may be substantially cylindrical. The one or more recesses may have one or more recess portions. One or more recess portions may include a single or a plurality of recess portions. One or more recess portions may include a first recess portion, second recess portion, or both. One or more recess portions may be adjacent to, in communication with, or both one or more other recess portions, a rotor gap, or both. For example, a first recess portion may be adjacent to and in communication with a second recess portion.

One or more recesses may have a length. A length of a recess may be a length it extends into a body. A length of a recess may be measured from an open end of a recess to an inward facing surface of a caliper body. A length of a recess may be measured substantially parallel to a rotational axis, axis of a recess, or both. A length of a recess may be measured substantially perpendicular to an inward facing surface, rotor surface, transverse plane, or a combination thereof. A length of a recess may be about 10% or greater, about 30% or greater, or even about 40% or greater than an overall thickness of a caliper side (e.g., outboard side, inboard side). A length of a recess may be about 90% or less, about 70% or less, or even about 60% or less than an overall thickness of a caliper side (e.g., outboard side, inboard side). A length of a recess may be about 5% or greater, about 10% or greater, or even about 15% or greater than a width of a rotor gap. A length of a recess may be about 50% or less, about 40% or less, or even about 30% or less than a width of a rotor gap. The width of a rotor gap may refer to a width of a rotor gap including or excluding a length of at least a portion of a recess.

The one or more recesses, recess portions, or both may have a width (e.g., diameter). A width may be measured substantially parallel to one or more inward facing surfaces, rotor surfaces, transverse planes, or a combination thereof. A width may be measured substantially perpendicular to one or more rotational axes. The one or more recesses, recess portions, or both may have a substantially constant width, variable width, or a combination of both. One or more recesses, recess portions, or both may have a width less than, about equal to, or larger than one or more other recesses, recess portions, gap plates, plate portions, cylinder bodies, pistons, or a combination thereof. For example, a first recess portion may have a width greater than a width of a second recess portion. A width of a recess portion may be sized to retain a portion of a gap plate. A width of a recess portion may be about equal to or larger than a width of a portion of a gap plate to have the gap plate located therein. For example, a width of a first recess portion may be equal to or larger than a width of a first plate portion. The first plate portion may then rest within the first recess portion and form an inward facing surface. A width of a recess portion may be about equal to or smaller than a width of a gap plate to have a friction fit with the portion of the gap plate. For example, a second recess portion may have a width less than or about equal to a width of a second plate portion. Thus, the second plate portion may have a friction fit with the second recess portion.

The one or more caliper bodies may include one or more gap plates. The one or more gap plates may function to cover one or more recesses, decrease a size of a rotor gap, provide an inward facing surface, contact a rotor to create a brake force, or any combination thereof. The one or more gap plates may form at least a portion of one or more inward facing surfaces when located in one or more recesses. The one or more gap plates may be removable, semi-permanently attached, permanently attached, or a combination thereof to a caliper body to form part of the caliper body. For example, one or more gap plates may be removably affixed to an outboard side of a caliper body. The one or more gap plates may be affixed with one or more adhesives, fasteners, a fit, the like, or a combination thereof. For example, one or more gap plates may have a friction fit with an outboard side of a caliper body. The one or more gap plates may reside within a portion of a caliper body. One or more gap plates may reside within one or more recesses. The one or more gap plates may have any shape suitable for residing at least partially within a caliper body. The one or more gap plates may be at least partially reciprocal with a shape of one or more recesses. The one or more gap plates may include one or more inward facing surfaces. The one or more inward facing surfaces may be located opposite one or more cylinder bodies, openings, other inward facing surfaces, or a combination thereof. The one or more inward facing surfaces of a gap plate may be recessed from, flush with, or project beyond one or more other inward facing surfaces of a caliper body (e.g., inboard side, outboard side). The one or more gap plates may extend partially or completely into one or more caliper bodies. The one or more gap plates may extend partially into a caliper body. The one or more gap plates may extend partially from an inward facing surface of a caliper body toward an exterior facing surface. For example, one or more gap plates may extend from an inward facing surface of an outboard side partially toward the exterior facing surface. The one or more gap plates may be located between an exterior facing surface and a bridge structure. The one or more exterior facing surfaces may include an exterior facing surface substantially opposite of a bridge structure. For example, the one or more gap plates may be located between an exterior facing surface of the outboard side opposite the bridge structure and the bridge structure. The one or more gap plates may have any suitable shape for, at least temporarily, decreasing a width of a rotor gap, allowing contact of one or more inward facing surfaces with a rotor, or both. The one or more gap plates may have a shape which is substantially cylindrical, spherical, conical, cubical, cuboidal, prismed, the like, or a combination thereof. The one or more gap plates may have a shape which is partially or completely reciprocal with one or more recesses, cylinder bodies, pistons, or a combination thereof. For example, one or more gap plates may be substantially cylindrical.

The one or more gap plates may have one or more plate portions. One or more plate portions may include a single or a plurality of plate portions. One or more plate portions may include a first plate portion, second plate portion, or both. One or more gap plates, plate portions, or both may be directly adjacent to, distanced from, or both one or more other gap plates, plate portions, or both. For example, a first plate portion may be directly adjacent to a second plate portion. One or more plate portions may reside in the same or differing one or more recess portions. For example, a first plate portion may reside in a first recession portion while a second plate portion resides within a second recess portion.

One or more gap plates, plate portions, or both may have a width. One or more gap plates, plate portions, or both may have a constant width, variable width, or both. A width of a plate portion may be measured as a width substantially parallel to a transverse plane, inward facing surface, opposing surfaces of a rotor, or a combination thereof. A width of a plate portion may be a diameter. One or more gap plates, plate portions, or both may have a width less than, about equal to, or greater than a width of one or more other gap plates, plate portions, cylinder bodies, pistons, or a combination thereof. A width of a plate portion may be about equal to a width of a piston, cylinder body or both. For example, a first plate portion may have a width about equal to a piston width (e.g., diameter). The first plate portion may apply a counter or reaction force to a rotor as the brake apply force applied by the piston, thus creating the brake force. Having a first plate portion about equally sized with the brake piston may allow for equal distribution of forces across the opposing rotor surfaces. A width of a gap plate, plate portion, or both may be sized to remain within a recess, recess portion, or both. A width of a gap plate, plate portion, or both may be smaller than or about equal to a width of a recess, recess portion or both. Thus, the gap plate, plate portion, or both may reside within the recess, recess portion, or both. A width of a gap plate, plate portion, or both may be about equal to or larger than a width of a recess, recess portion, or both. Thus, the gap plate, plate portion, or both may have a friction fit within the recess, recess portion, or both.

The one or more caliper bodies may include one or more openings. The one or more openings may function to receive, engage, or both with one or more cylinder bodies to form a caliper housing. The one or more openings may be formed in a caliper body. The one or more openings may be located within an inboard side, outboard side, or both. The one or more openings may extend partially or completely through an inboard side, outboard side, or both. The one or more openings may extend from an inward facing surface to an outward facing surface. For example, one or more openings may extend from an inward facing surface to an outward facing surface of an inboard side. The one or more openings may receive one or more cylinder bodies therethrough. The one or more openings may have a size and/or shape suitable for receiving, engaging, or both one or more cylinder bodies. The one or more openings may have a shape reciprocal with at least a portion of one or more cylinder bodies. For example, the one or more openings may have a shape reciprocal with a cylindrical wall of a cylinder body. The one or more openings may have one or more engagement features. One or more engagement features may function to position, mate, or both with one or more engagement features of one or more cylinder bodies. One or more engagement features of an opening may be reciprocal with one or more engagement features of a cylinder body. One or more engagement features may include one or more keys, slots, ribs, channels, notches, tabs, the like, or any combination thereof. The one or more engagement features may be affixed to or formed as part of an inner surface of the one or more openings. One or more engagement features of the opening may receive, be received, mate with, or any combination thereof with one or more engagement features of a cylinder body. The one or more openings may have a size suitable for allowing at least a portion of one or more cylinder bodies to pass therethrough, preventing a portion of one or more cylinder bodies from passing therethrough, or both. A size of an opening may refer to a diameter, width, cross-sectional area, or any combination thereof. The size of the opening may be referred to as an inner diameter. The one or more openings may have a size less than, about equal to, greater than, or a combination thereof to one or more portions of one or more cylinder bodies. For example, an inner diameter of the one or more openings may be smaller than an outer diameter of a flange of one or more cylinder bodies. The one or more portions may refer to a cylindrical wall, open end, end wall, flange, or a combination thereof. The one or more openings may be engaged with one or more cylinder bodies. An inner surface (e.g., interior circumference) of one or more openings may be engaged with an outer surface of one or more cylinder bodies. The one or more openings may have a friction fit, press fit, snap fit, the like, or a combination thereof with the one or more cylinder bodies. An inner surface of one or more openings may be adhered to one or more cylinder bodies. One or more fasteners may pass through a portion of the caliper body past the inner surface of one or more openings and into the one or more cylinder bodies. The one or more openings may be located anywhere between opposing ends of the caliper. One or more openings may be located closer toward a leading end or trailing end, centrally between a trailing end and a leading end, or a combination thereof. The one or more openings may be in communication with one or more fastener bores.

One or more caliper bodies may include one or more fastener bores. The one or more fastener bores may function to receive one or more fasteners, cooperate with one or more fasteners to secure one or more cylinder bodies relative to one or more caliper bodies, or both. The one or more fastener bores may be formed in one or more caliper bodies, cylinder bodies, or both. The one or more fastener bores may be aligned with one or more other fastener bores. One or more fastener bores of one or more caliper bodies may be aligned with one or more fastener bores of one or more cylinder bodies. Aligned may refer to the one or more fastener bores being overlapping, co-axial, centered, or a combination thereof relative to one or more other fastener bores. The one or more fastener bores may have a uniform width (e.g., diameter) along its length, a variable width along its length, or both. One or more fastener bores may include or be free of a counterbore, countersink, or both. A counterbore or countersink may be useful in providing a space for a head of a fastener to sit flush or below an exterior surface of a caliper body. A counterbore or countersink may provide an area for a seal between a fastener and a surface of the caliper body. The one or more fastener bores may include or be free of one or more mating features for mating with one or more fasteners. One or more mating features may include a threaded surface, adhesive, engagement features, the like, or any combination thereof. The one or more fastener bores may be formed in one or more surfaces of one or more caliper bodies. The one or more surfaces of a caliper body may include one or more inward facing surfaces, outward facing surfaces, exterior surfaces, interior surfaces, the like, or a combination thereof. The one or more surfaces of a caliper body may include any surface adjacent to, in contact with, or both one or more surfaces of one or more cylinder bodies. For example, one or more fastener bores may be formed in an inner surface of an opening of a caliper body. Thus, one or more fastener bores may be in communication with one or more openings. The one or more fastener bores may pass partially or completely from one surface of a caliper body to another surface of a caliper body. For example, the one of more fastener bores may extend from an inner surface of an opening to an outward facing surface of the caliper body. The outward facing surface of the caliper body may include a surface adjacent to, opposite from, in proximity to, or a combination thereof one or more inward facing surfaces of the caliper body. For example, one or more fastener bores may be located on an outward facing surface of the inboard side of a caliper body which is adjacent to an inward facing surface facing toward a rotor gap. The outward facing surface of the caliper body may include an exterior surface substantially opposite an interior surface of an opening, bridge structure, or both.

The caliper housing may include a bridge structure. The bridge structure may function to connect one or more sides of a caliper body to another, one or more caliper bodies to one another, or both; to reinforce against deflection of one or more caliper bodies during application of a brake force; or a combination thereof. The bridge structure may have any size or shape to connect one or more sides of one or more caliper bodies with one or more other sides of one or more caliper bodies, extend over a rotor gap, or both. The bridge structure may be located radially outward from one or more caliper bodies, cylinder bodies, openings, fastener bores, a rotor, a rotor gap, or any combination thereof. The bridge structure may be integral with or attached to one or more caliper bodies. For example, in a monoblock caliper, the bridge structure may be integral with both an inboard side and an outboard side of a caliper body. As another example, in a two-piece caliper, the bridge structure may be integrally formed with an inboard side or an outboard side and affixed via a fastener to the outboard side or inboard side. The bridge structure may extend from one or more sides to one or more opposing sides of a caliper body. For example, the bridge structure may extend from an inboard side to an outboard side. The bridge structure may extend over a rotor gap in a linear and/or arc-like fashion. The bridge structure may extend from one side to an opposing side of the caliper body. The bridge structure may be located between opposing sides of the caliper body. The bridge structure may extend though one or more planes. The bridge structure may extend through the transverse plane. The bridge structure may be symmetrical or asymmetrical about one or more planes. For example, the bridge structure may be substantially symmetrical about a longitudinal plane. The bridge structure may include one or more reinforcing structures, one or more through-holes, or both. Exemplary bridge structures may be those disclosed in U.S. Pat. No. 9,989,112; and US Patent Application Publication No.: 2018-0187730; incorporated herein by reference in their entirety for all purposes.

The bridge structure may include one or more reinforcing structures. The one or more reinforcing structures may function to prevent displacement of one or more sides relative to one or more other sides of one or more caliper bodies during application of a brake force. Displacement may generally include separation of an outboard side from an inboard side in a direction away from the rotor or opposite the brake force; separation of the outboard side from the inboard side in a direction generally perpendicular with the rotational axis of a rotor, which may be referred to as rhombus mode displacement; bending or twisting of the outboard side and/or the inboard side producing a twisting mode displacement; or any combination thereof. One or more reinforcing structures may include a single reinforcing structure or a plurality of reinforcing structures. One or more reinforcing structures may extend from one or more sides of one or more caliper bodies. One or more reinforcing structures may extend from an inboard side, an outboard side, or both. One or more reinforcing structures may extend from an exterior surface and/or an interior surface of one or more caliper bodies. One or more reinforcing structures may be integrally formed and/or affixed to one or more caliper bodies. For example, one or more reinforcing structures may be integral with both an inboard side and an outboard side of a caliper body. One or more reinforcing structures may extend toward one or more sides of one or more caliper bodies, one or more planes, one or more other portions of a bridge structure, or any combination thereof. One or more reinforcing structures may extend partially or completely the distance from an inboard side to an outboard side of one or more caliper bodies. The one or more reinforcing structures may have a thickness and/or height which is substantially uniform, variable, or both. The one or more reinforcing structures may taper or increase in thickness and/or height as the reinforcing structure approaches or extends away from one or more sides. Thickness may be a width of a reinforcing structure measured generally parallel with a transverse plane. Height may be a width of a reinforcing structure measured generally parallel with a longitudinal plane. The one or more reinforcing structures may have or form one or more shapes generally resembling a V, X, W, H, I, the like, or any combination thereof. The one or more reinforcing structures may cooperate with one or more other portions of the bridge structure and/or one or more sides of one or more caliper bodies to form one or more through-holes. Exemplary reinforcement structures may be those disclosed in U.S. Pat. No. 9,989,112; and US Patent Application Publication No.: 2018-0187730; incorporated herein by reference in their entirety for all purposes.

One or more caliper bodies may include one or more through-holes. One or more through-holes may function to allow the rotor gap, rotor, and/or brake pads to be in communication with an ambient environment surrounding a brake assembly to allow for heat dissipation; allow for weight to be reduced from a bridge structure while a plurality of reinforcing structures provide sufficient structural support to prevent displacement; or any combination thereof. One or more through-holes may be located above (i.e., radially outward from) the rotor gap. One or more through-holes may be formed in one or more bridge structures, sides, or both of one or more caliper bodies. For example, one or more through-holes may be located in a bridge structure. One or more through-holes may be formed by one or more portions of a bridge structure. One or more portions may include one or more reinforcing structures. For example, one or more through-holes may be formed by the space between two or more reinforcing structures of a bridge structure. One or more through-holes may be formed by an area enclosed by one or more surfaces of one or more portions of a bridge structure, one or more sides of one or more caliper bodies, or any combination thereof. One or more through-holes may be located on one or more sides of one or more planes of the caliper housing. One or more through-holes may be located on one or both sides of a transverse plane of the caliper housing. One or more through-holes may be located on one or both sides of a longitudinal plane of the caliper housing. One or more through-holes may be asymmetrical or symmetrical about one or more planes. One or more through-holes may be asymmetrical or symmetrical with one or more other through-holes about one or more planes. Exemplary through-holes may be those disclosed in U.S. Pat. No. 9,989,112; and US Patent Application Publication No.: 2018-0187730; incorporated herein by reference in their entirety for all purposes.

The caliper housing includes one or more cylinder bodies. The one or more cylinder bodies may function to house one or more pistons, linear motion mechanisms, brake fluid, seals, or any combination thereof. The one or more cylinder bodies may be located on any portion of the caliper housing which allows a cylinder body to house one or more pistons so that the one or more pistons may be actuated toward a rotor. The one or more cylinder bodies may include a single cylinder body or a plurality of cylinder bodies. The inboard side, outboard side, or both may include one or more cylinder bodies, two or more cylinder bodies, three or more cylinder bodies, or even four or more cylinder bodies. The inboard side, outboard side, or both may include ten or less cylinder bodies, eight or less cylinder bodies, or even six or less cylinder bodies. Each side of the caliper housing may have an equal or differing number of cylinder bodies as an opposing side of the caliper housing. As one example, in a fixed caliper the outboard side may have the same number of cylinder bodies as the inboard side. As another example, in a floating caliper, the outboard side may be free of cylinder bodies while the inboard side may include one or more cylinder bodies. One or more cylinder bodies may be generally opposing one or more other cylinder bodies, may face an inward surface of the caliper body, or both. One or more cylinder bodies may be co-axial or axially off-set with one or more other cylinder bodies. The one or more cylinder bodies may include one or more end walls, open ends, cylindrical walls, hollow interiors, flanges, fastener bores, fluid inlets, spindle inlets, axes, the like, or a combination thereof. The one or more cylinder bodies have a length. The length may be a distance from one end of a cylinder body to an opposing end, from an end wall to an open end, from an end wall to a flange, or any combination thereof. The length may be measured substantially along a longitudinal axis of the cylinder body. The length of the cylinder body may allow the cylinder body to be placed into the caliper body via the rotor gap. The length of the cylinder body may be less than, equal to, or greater than a width of a rotor gap. The length of a cylinder body may be about 0.5 times or greater, about 0.7 times or greater, or even about 0.9 times or greater than a width of a rotor gap. The length of a cylinder body may be about 1.5 times or less, about 1.3 times or less, or even about 1.1 times or less than a width of a rotor gap. The one or more cylinder bodies may be engaged with one or more caliper bodies such that they are non-movable relative to one another. The one or more cylinder bodies may be press-fit, fastened, adhered, or any combination thereof into one or more openings such that the one or more cylinder bodies are non-moveable relative to the one or more openings. The one or more cylinder bodies may include an axis (e.g., longitudinal axis). An axis of the one or more cylinder bodies may be perpendicular to opposing surfaces of a rotor, one or more inward facing surfaces of a caliper body, a transverse plane, or any combination thereof. The axis may be parallel with a rotational axis of a rotor, a longitudinal plane of a caliper housing, a longitudinal axis of an opening, or any combination thereof. The axis of a cylinder body may be coaxial with a longitudinal axis of an opening. The one or more cylinder bodies may be located radially outward from a rotational axis, one or more fastener bores, or both.

The one or more cylinder bodies may include one or more cylindrical walls. The one or more cylindrical walls may have a size and/or shape which is generally complementary (e.g., reciprocal) with one or more pistons, openings, or both. The shape of the piston cylindrical wall may be cylindrical, spherical, conical, cubical, cuboidal, prismed, the like, or a combination thereof. For example, the cylindrical wall may be generally cylindrical. The cylindrical wall may extend from an end wall to an open end, a flange, or both of the cylinder body. The cylindrical wall may be integral with or attached to an end wall. The cylindrical wall includes an outer diameter. The outer diameter may be a straight line distance from one side of an exterior wall of the cylindrical wall to an opposing side of the exterior wall through the center of the cylindrical wall. The outer diameter may be such a size that at least a portion of the cylindrical wall may be able to fit within, pass through, have a friction fit, or a combination thereof with an opening of one or more caliper bodies. The outer diameter may be uniform or may vary along the length of the cylindrical wall. At least a portion of the cylindrical wall may be tapered. For example, an outer diameter of the cylindrical wall closer to the end wall may be smaller than an outer diameter of the cylindrical wall closer to the flange or open end. A smaller outer diameter near the end wall may allow the cylinder body to be inserted through an opening. A larger outer diameter near the open end may allow the cylinder body to be engaged with (e.g., friction fit) the opening. The cylindrical wall may have an outer diameter about 0.5 times or greater, about 0.6 times or greater, about 0.7 times or greater, or even about 0.8 times or greater relative to a length of a cylinder body. The cylindrical wall may have an outer diameter about 1.5 times or less, about 1.4 times or less, about 1.3 times or less, or even about 1.2 times or less relative to a length of a cylinder body. The cylindrical wall may include one or more engagement features. The one or more engagement features suitable for the opening may be suitable for the cylindrical wall. The one or more engagement features may be reciprocal to those one or more engagement features of the opening. The one or more engagement features may be attached to or formed as part of the cylindrical wall. The one or more engagement features may be part of an exterior wall of the cylindrical wall. The cylindrical wall may define a hollow interior of the cylinder body. An exterior wall may be opposite an interior wall of the cylindrical wall. The interior wall may form a wall of the hollow interior. The hollow interior may have any size and/or shape suitable for housing a piston, linear motion mechanism, brake fluid, or combination thereof. The hollow interior may have a shape substantially reciprocal with an exterior of a piston. The interior wall may be substantially smooth or include one or more grooves. One or more grooves may include an annular groove (i.e., seal groove). The annular groove may be located substantially near the open end of the cylinder body, adjacent to a flange, or both. For example, the annular groove may be formed in the interior wall opposite a flange located about the exterior wall of the cylinder body. A seal may be located about the annular groove to form an interference fit with the piston. The seal may prevent brake fluid from leaking from the open end of the cylinder body, contaminants (e.g., dust, oil) from entering the cylinder body, or both.

The one or more cylinder bodies may include one or more flanges. The one or more flanges may function to maintain a position of a cylinder body relative to a caliper body, mate a cylinder body relative to a caliper body, reinforce a connection of a cylinder body to a caliper body, or any combination thereof. The one or more flanges may be located anyone along the cylinder body such that they may function to maintain a position of a cylinder body relative to a caliper body. The one or more flanges may be integral with or affixed to the cylindrical wall of the cylinder body. The one or more flanges may be located partially or completely about a circumference of cylindrical wall. The one or more flanges may project from a surface of the cylinder body. The one or more flanges may project substantially perpendicular relative to an exterior wall, longitudinal axis, or both of the cylindrical wall. The one or more flanges may be continuous or discontinuous. The one or more flanges may have an outer diameter greater than an outer diameter of the cylindrical wall, inner diameter of one or more openings, or both. The outer diameter may be a straight line distance from one side of an exterior wall of the flange to an opposing side of the exterior wall of the flange through the center of the cylindrical wall, flange, or both. The one or more flanges may have an outer diameter about 1.05 times or greater, about 1.1 times or greater, about 1.2 times or greater, or even about 1.25 times or greater than an outer diameter of the cylindrical wall, inner diameter of an opening, or both. The one or more flanges may have an outer diameter about 2 times or less, about 1.8 times or less, about 1.6 times or less, about 1.4 times or less, or even about 1.3 times or less than an outer diameter of the cylindrical wall, inner diameter of an opening, or both. The one or more flanges may have a thickness sufficient to maintain a position of, reinforce, or both the cylinder body. A thickness of the flange may be measured as the distance between opposing surfaces of the flange, parallel to a longitudinal axis of the cylinder body, or both. A thickness of the flange may be relative to an overall length of the cylinder body. A thickness of the flange may be about 1% or greater, about 5% or greater, or even about 10% or greater of the total length of the cylinder body. A thickness of the flange may be about 25% or less, about 20% or less, or even about 15% or less of the total length of the cylinder body. The one or more flanges may be located at, closer toward, adjacent to, or a combination thereof relative to the open end, end wall, or both. The one or more flanges may be located closer toward the open end than the end wall. The one or more flanges may be located at the open end, about the open end, distanced from the open end, or a combination thereof. The one or more flanges may be distanced from the open end by about 1% or greater, about 2% or greater, about 5% or greater, about 7% or greater, or even by about 10% or greater of the overall length of the cylinder body. The one or more flanges may be distanced from the open end by about 25% or less, about 20% or less, about 18% or less, or even by about 15% or less of the overall length of the cylinder body. When one or more cylinder bodies are assembled to one or more caliper bodies, the one or more flanges may abut with one or more surfaces of the caliper body. The one or more surfaces may include an inward facing surface of an inboard side, outboard side, or both. For example, the one or more cylinder bodies may include a flange located within a rotor gap of a caliper housing and which abuts with an inward facing surface of the inboard side of a caliper body.

The one or more cylinder bodies may include one or more fastener bores. The one or more fastener bores may function to receive one or more fasteners, cooperate with one or more fasteners to secure one or more cylinder bodies relative to one or more caliper bodies, maintain a position of one or more cylinder bodies relative to one or more caliper bodies, or any combination thereof. The one or more fastener bores may be aligned with one or more other fastener bores. One or more fastener bores of one or more cylinder bodies may be aligned with one or more fastener bores of one or more caliper bodies. The one or more fastener bores may be designed similar to the one or more fastener bores suitable for the one or more caliper bodies. The one or more fastener bores may be formed in one or more surfaces of a cylinder body. The one or more surfaces of a cylinder body may include a surface adjacent to, in contact with, or both one or more surfaces of a caliper body. The one or more fastener bores may be located in a cylindrical wall, flange, end wall, or a combination thereof. The one or more fastener bores may be located along a length of a cylindrical wall resting within an opening of a caliper body, resting outside of an opening of a caliper body, adjacent to an opening of a caliper body, adjacent to an exterior surface of a caliper body, or a combination thereof. The one or more fastener bores may be located between a flange and an end wall of a cylinder body. The one or more fastener bores may be located closer to one of, centered between, or a combination thereof an open end, flange, and/or an end wall of the cylinder body. The one or more fastener bores may be located about ⅛ or greater, about ¼ or greater, about ⅓ or greater, or even about ½ or greater of the length of the cylinder body from an open end, end closest to a rotor gap, or both. The one or more fastener bores may be located about ⅞ or less, about ¾ or less, or even about ⅔ or less of the length of the cylinder body from an open end, end closest to a rotor gap, or both. The one or more surfaces of a cylinder body may include one or more one or more exterior walls, interior walls, or both of a cylindrical wall. For example, one or more fastener bores may pass through a cylindrical wall from an exterior wall to an interior wall. The one or more fastener bores may face toward a portion of a piston within the cylinder body. The one or more fastener bores may be aligned with a slot of a piston.

The one or more cylinder bodies may include an open end. The open end may allow for a piston to move toward a rotor through the cylinder body, transfer a brake apply force to a brake pad, or both. The open end may have any size and/or shape suitable for allowing a piston to move therethrough. The open end may define a rim of the cylinder body. The open end may provide access to a hollow interior of the cylinder body. The open end may face toward the rotor gap. The open end may be located adjacent to a flange of a cylinder body. The open end may include a flange about its perimeter or may be distanced from a flange. When the cylinder body is assembled to a caliper body, the open end may be located between a pressure pad and an inward facing surface of a caliper housing. The open end may be located opposite an end wall of one or more cylinder bodies.

The one or more cylinder bodies may include an end wall. The end walls may function to receive a brake fluid, seal an interior of a cylinder body, receive an input for one or more linear motion mechanisms, or any combination thereof. The end wall may be located opposite an open end of a cylinder body. The closed wall may be connected to an open end, one or more flanges, or both via a cylindrical wall. The end wall may include one or more fluid inlets, spindle inlets, or both. A fluid inlet may be in fluid communication with a master cylinder. The fluid inlet may allow for brake fluid to enter the cylinder body so that the piston is moved toward the open end, brake pad, or both. For example, a fluid inlet may be provided in a cylinder body which is part of a hydraulic brake. A spindle inlet may allow for a portion of a linear motion mechanism to be in communication with a drive source. For example, a spindle inlet may be provided in a cylinder body which is part of an electromechanical brake. A spindle inlet may allow for torque to transfer for a drive source to a linear motion mechanism located within a cylinder body. A spindle inlet may be formed as an opening in the end wall. A spindle inlet may allow for a least a portion of a linear motion mechanism to extend therethrough. A portion of a spindle may extend through the spindle inlet.

The caliper housing may include one or more fasteners. One or more fasteners may include a single fastener or a plurality of fasteners. The one or more fasteners may function to secure one or more bodies of the caliper housing to one or more other bodies, restrict movement of one or more bodies of the caliper housing relative to one or more other bodies, guide movement of a piston within a caliper housing, or any combination thereof. The one or more fasteners may cooperate with one or more fastener bores, flanges, openings, cylinder bodies, caliper bodies, or any combination thereof to restrict movement of a piston relative to a cylinder body, caliper body, or both; a cylinder body relative to a caliper body; or a combination thereof. The one or more fasteners may be any fastener capable of securing one or more bodies to one or more other bodies of a caliper housing. The one or more fasteners may include one or more mechanical fasteners, adhesive materials, molded fasteners, the like, or any combination thereof. A mechanical fastener may include a threaded fastener, a press-fit fastener, a snap-fit fastener, a staple, the like, or any combination thereof. A threaded fastener may include a screw, a bolt, a stud, a nut, or any combination thereof. A threaded fastener may include a shaft having a head at one end. An adhesive material may include an adhesive, a sealant, a tape, a material suitable for soldering, or any combination thereof. The adhesive material may include any material suitable for adhering metal to metal. The adhesive may include an epoxy, an acrylic, a urethane, the like, or any combination thereof. A molded fastener may include or be formed by a heat stake, welding, peening, the like, or any combination thereof. One or more fasteners may secure one or more bodies to one or more other bodies. One or more fasteners may secure a caliper body to a cylinder body. One or more fasteners may be located in, engaged with, or both one or more fastener bores. One or more shafts of a fastener may be disposed within, engaged with, or both one or more fastener bores. A head of a fastener may sit within a countersink, counterbore, or an exterior surface of one or more bodies. One or more fasteners may have one or more seals located at least about at least a portion of the fastener. One or more fasteners may extend partially or completely through one or more bodies, one or more portions of one or more bodies, one or more pistons, or any combination thereof. One or more fasteners may extend through all or a portion of an inboard side, outboard side, or both of a caliper body. One or more fasteners may extend through all of a portion of a cylindrical wall, end wall, flange, or a combination thereof of a cylinder body. One or more fasteners may extend through a fastener bore of a caliper body, cylinder body, or both. One or more fasteners may be perpendicular, parallel, and/or any angle therebetween relative to one or more planes, one or more inward facing surfaces of one or more caliper bodies, a longitudinal axis of a cylinder body, opposing surfaces of a rotor, one or more other fasteners, or any combination thereof. One or more planes may include a transverse plane and/or a longitudinal plane. One or more fasteners may extend into a body at an acute angle, right angle, obtuse angle, or straight angle relative to a longitudinal axis of a cylinder body. One or more fasteners may be engaged with a piston. One or more fasteners may aid in moving of a piston to and from a brake apply position. One or more fasteners may reside within a slot of a piston. One or more fasteners may remain fixed while one or more pistons are moveable. For example, a fastener may remain fixed while a piston moves axially during a brake apply, brake release, or both.

The caliper housing may include one or more seals. One or more seals may function to prevent contaminants from entering into a cylinder body, prevent leakage of one or more fluids (e.g., brake fluid) from a cylinder body, reinforcing one or more fasteners, or any combination thereof. The one or more seals may include any seal suitable for providing a seal, being exposed to brake fluid, securing one or more fasteners, or a combination thereof. The one or more seals may be located near, adjacent to, or in contact with one or more openings, fastener bores, or both of a cylinder body, caliper body, piston, or any combination thereof. The one or more seals may be located between a fastener and an adjacent surface of a fastener bore, between two surfaces mated by a fastener, the like, or any combination thereof. The one or more seals may be located at least partially about, adjacent to, or both, a surface of one or more fasteners. The one or more seals be located at least partially or fully about a shaft, adjacent to a head, or both. The one or more seals may be an adhesive material, compression material, the like, or a combination thereof. An adhesive material may include a thread-locking adhesive, a thread sealant adhesive, a gasket sealant, a flange sealant, the like, or any combination thereof. An adhesive material may be ester-based, epoxy-based, the like, or any combination thereof. Suitable exemplary seals may include Grade H, Grade E, or Grade CV Thread Sealants by LOCTITE®. A compression material may be comprised of silicone, rubber, the like, or any combination thereof. Exemplary seals made of a compression material may include a gasket, O-ring, thread-seals, the like, or any combination thereof.

The caliper housing may include one or more pistons. The piston may be useful in receiving and transferring a brake apply force; be in communication with a linear motion mechanism; be in contact with brake fluid, move axially upon receiving a brake apply force from brake fluid and/or linear motion mechanism; be in contact with a brake pad, push a brake pad axially to transfer a brake apply force, or any combination thereof. The piston may be any size and/or shape suitable for receiving and transferring a brake apply force, be in contact with brake fluid, move axially upon receiving a brake apply force from brake fluid, be in contact with a brake pad, push a brake pad axially to transfer a brake apply force, or any combination thereof. The piston may have any size and/or shape which is generally complementary to a cylinder body of a caliper housing to allow axial movement of the piston within the cylinder body. The piston may have any size and/or shape for housing at least a portion of a linear motion mechanism. The shape of the piston may generally be cubical, spherical, cylindrical, coned, the like, or any combination thereof. For example, the piston may be generally cylindrical with a hollow interior. The piston may include a longitudinal axis. The longitudinal axis may extend along a length of the piston from one end to an opposing end. The piston may include a piston cylindrical wall, a slot, a linear motion mechanism, or any combination thereof.

The piston may include a piston cylindrical wall. The piston cylindrical wall may be any size and/or shape capable of sliding inside a cylinder body. The piston cylindrical wall may have a size and/or shape which is generally complementary to a cylinder body of the caliper. The shape of the piston cylindrical wall may be cubical, spherical, cylindrical, coned, the like, or any combination thereof. For example, the piston cylindrical wall may be generally cylindrical. The piston cylindrical wall may extend from one end to an opposing end of the piston. The piston cylindrical wall includes a length. The length may be the distance from one end to an opposing end of the piston. The length may be any distance which may allow one or both ends to contact a brake fluid, receive or be received by a linear motion mechanism, receive a pressure or force from the brake fluid, receive a force from a linear motion mechanism, contact a friction material, push and move the friction material, or any combination thereof. The length of the piston cylindrical wall may be equal to or less than the length of the piston. The length of the piston cylindrical wall may be about equal to the length of the piston cylinder less a thickness of a closed end. The piston cylindrical wall may include an outer diameter. The outer diameter may be a straight line distance from one side of an exterior wall of the piston cylindrical wall to an opposing side of the exterior wall through the center of the piston cylindrical wall. The outer diameter may be any size such that the piston cylindrical wall may be able to fit within a cylinder body. The outer diameter may be the uniform, change, or both along the length of the piston. For example, a groove in the piston cylindrical wall may have a smaller or larger outer diameter than another portion of the piston cylindrical wall, the open end may have a smaller or larger outer diameter than the closed end, or both. The piston cylindrical wall may include an annular groove, such as that described in U.S. Pat. No. 4,449,447 and US Patent Publication No. 2016/0146345, incorporated herein by reference in their entirety for all purposes. The annular groove may be useful for fitting with a piston boot. The annular groove may be formed in an exterior wall of the piston cylindrical wall.

The piston may have one or more slots. The one or more slots may cooperate with one or more portions of a caliper housing to maintain alignment, prevent rotation, or both of a piston during a brake apply, brake release, or both. The one or more slots may cooperate with one or more fasteners, fastener bores, engagement features, or any combination thereof to maintain alignment of the piston relative to a caliper body, cylinder body, or both. For example, the one or more slots may receive a portion of a shaft of one or more fasteners therein. The one or more slots may have any suitable shape for engaging with one or more fasteners, engagement features, or both of a caliper housing. The one or more slots may be shaped like a channel, track, the like, or a combination thereof. For example, the one or more slots may be shaped like a C-channel. The one or more slots may be formed in a piston cylindrical wall. The one or more slots may extend partially or completely through a thickness of the piston cylindrical wall. The thickness may be the distance from the exterior to the interior of the piston cylindrical wall. The one or more slots may extend through about 5% or greater, about 10% or greater, about 20% or greater, or even about 30% or greater of a thickness of the piston cylindrical wall. The one or more slots may extend through about 100% or less, about 80% or less, about 70% or less, or even about 50% or less of a thickness of the piston cylindrical wall. The one or more slots may extend along a length of the cylindrical wall. The one or more slots may have a length equal to or greater than a distance a maximum distance a piston may travel to transfer a brake apply force, brake release force, create a brake force, release a brake force, or any combination thereof. The one or more slots may have a length relative to a length of the piston cylindrical wall. The one or more slots may have a length of about 25% or greater, about 30% or greater, about 40% or greater, or even about 50% or greater than a length of the piston cylindrical wall. The one or more slots may have a length of about 100% or less, about 80% or less, or even about 60% or less than a length of the piston cylindrical wall. The one or more slots may extend along a length such that the slots may allow axial movement while preventing rotational movement of the one or more pistons during a brake apply, brake release, or both. The one or more slots may be located between opposing ends, a closed end to an open end, or both of a piston. The one or more slots may extend partially or completely one end to an opposing end, a closed end to an open end, or both of a piston. The one or more slots may extend from between the opposing ends toward one of the ends. For example, the one or more slots may have a length less than a length of the cylindrical wall and extend from between the opposing ends of the piston to the end furthest from a rotor gap (e.g., open end). The one or more slots may have a width. The width of the slot may cooperate with one or more fasteners, engagement features, or both to restrict rotational movement of the piston while allowing for axial movement. The width of the slot may allow the slot to move axially along a fastener, engagement feature, or both. The width of the slot may be smaller than, about equal to, or larger than a width or diameter of a fastener, engagement feature, or both. The width of the slot may be measured as the distance from one side wall of the slot opposing another side wall. The width of the slot may be measured relative to a width (e.g., diameter) of a piston cylindrical wall. The width of the slot may be about 5% or greater, about 7% or greater, or even about 10% than a width of the piston cylindrical wall. The width of the slot may be about 60% or less, about 50% or less, about 30% or less, about 20% or less, or even about 15% or less than a width of the piston cylindrical wall. The one or more slots may include a single slot or a plurality of slots. A plurality of slots may be spaced uniformly or randomly about the cylindrical wall. One or more slots may be aligned with one or more fastener bores of one or more caliper bodies, piston bodies, or both. For example, a single slot of a piston may have a longitudinal axis which is perpendicular with and intersects a longitudinal axis of one or more fastener bores and fasteners.

The piston may include or be affixed to a linear motion mechanism. The linear motion mechanism may function to convert a rotational force (i.e., torque) into a linear force, drive a piston axially to convert the rotational force into a linear force, or both. Any suitable linear motion mechanism suitable for driving a piston axially may be utilized. The linear motion mechanism may be in direct and/or indirect communication with the piston. The linear motion mechanism may be partially or completely located within a cylinder body, piston, or both. The linear motion mechanism may include a spindle, nut, or both. A spindle may be rotationally engaged with the nut. Rotational movement of a spindle may be converted to linear movement of a nut, rotational movement of a nut may be converted to linear movement of a spindle, or both. The nut may be separate from or may be part of the piston. The nut may be located within a hollow interior of the piston. The nut may have a shape substantially reciprocal with a portion of a hollow interior of the piston. For example, the nut may have one or more flats about a perimeter which a reciprocal with one or more flats within an interior of the piston. The reciprocal shape may restrict rotational movement of the nut relative to the piston. As an alternative, the nut may be formed by at least a portion of the piston cylindrical wall. The nut may have a wall which defines a bore. The wall may be separate from or part of the piston cylindrical wall. The bore includes a helical thread along its length. The helical thread functions to engage with a helical thread of the spindle. The spindle may reside within the bore of the nut. The spindle includes a helical thread about an exterior. In the linear motion mechanism, the spindle and the nut are in a mating relationship so that the helical threads of the spindle and the nut are mated within one another. One of the spindle or the nut may be restricted from rotating, free to rotate, or both. For example, a nut may be adhered to or part of a piston thus preventing its rotation relative to the piston and the spindle. The spindle may include a spindle inlet. The spindle inlet may function to connect the spindle to a drive source. The spindle inlet may be in direct or indirect communication with a drive source. The drive source may include a motor. A motor may apply a rotational force to the linear motion mechanism. The motor may apply a rotational force to the spindle, nut, or both. Examples of linear motion mechanisms suitable for residing within a piston are disclosed in US Patent Application Publication No.: 2017-0370453, incorporated herein by reference in its entirety for all purposes.

The disclosure further relates to a method for forming a caliper housing according to the teachings herein. The present teachings may be performed in virtually any order. One or more features of the caliper housing and/or brake assembly taught herein may be provided. The method may include any or all of the following steps.

The method for forming a caliper housing may include forming one or more bodies of a caliper housing. Forming may include machining from billet, casting, forging, the like, or any combination thereof. Forming may include forming one or more bodies separately from one or more other bodies. Forming may include forming one or more cylinder bodies and one or more caliper bodies separate from one another. Forming may include forming one or more caliper bodies having a bridge structure integral with one or more sides. Forming may include affixing one or more sides of a caliper body to another side of a caliper body. Affixing may include applying an adhesive, engaging a fastener, welding, soldering, brazing, the like, or any combination thereof. Forming may include creating one or more openings, fastener bores, or both in one or more bodies. Creating one or more bores may include casting, drilling, punching, the like, or any combination thereof.

The method for forming a caliper housing may include assembling a linear motion mechanism to a piston. Assembling may include assembling a linear motion mechanism. Assembling a linear motion mechanism may include engaging a spindle with a nut. Engaging a spindle with a nut may include engaging one or more helical threads of a spindle with one or more helical threads of a bore of a nut. Assembling may include locating at least a portion of a linear motion mechanism into a piston. At least a portion of the linear motion mechanism may be inserted into a hollow interior of a piston. A portion may be inserted into the hollow interior via an open end. Assembly may include affixing at least a portion of a linear motion mechanism to a piston. Affixing may include attaching a nut or spindle to a piston such that it is non-moveable relative to the piston. Affixing may include attaching a nut to a hollow interior of a piston. Affixing may include one or more nuts residing within one or more reciprocal portions of the hollow interior of the piston. For example, the flats of a nut exterior may be reciprocal with flats of the hollow interior to prevent rotational movement of the nut relative to the piston.

The method for forming a caliper housing may include assembling a piston to a cylinder body. The method may include inserting a piston into a cylinder body. Insertion of the piston may occur before or after assembling a cylinder body to a caliper body. Assembling a piston to a cylinder body may include locating a portion of a spindle through a spindle inlet. Assembling of a piston to a cylinder body may include engaging of a seal. The seal may be a piston boot.

The method for forming a caliper housing may include assembling one or more bodies to one or more other bodies. One or more bodies may include one or more caliper bodies, cylinder bodies, or both. One or more cylinder bodies may be inserted into a rotor gap of a caliper housing. The one or more cylinder bodies may include or be free of a linear motion mechanism. One or more cylinder bodies may be inserted into one or more openings of one or more caliper bodies. One or more cylinder bodies may be inserted into one or more openings in an inboard side, outboard side, or both of one or more caliper bodies. One or more cylinder bodies may be inserted partially or completely through one or more openings. One or more cylinder bodies may be inserted into an opening until a flange of a cylinder body abuts with an inward facing surface of a caliper housing. One or more cylinder bodies may be located within one or more openings such that one or more fastener bores of the cylinder body are aligned with one or more fastener bores of the caliper body. The one or more fastener bores of the cylinder body may be aligned with one or more fastener bores formed in an inner surface of an opening. One or more cylinder bodies may be engaged with one or more caliper bodies. Engaging may include any friction fit, press fit, snap fit, the like, or a combination thereof with an inner surface of one or more openings of one or more caliper bodies. One or more cylinder bodies may be secured to one or more caliper bodies. Securing may include adhering, fastening, sealing, or any combination thereof. Adhering may include applying and curing one or more adhesives where one or more surfaces of a cylinder body are in contact with one or more surfaces of a caliper body. One or more surfaces may include an exterior surface of a cylindrical wall of a cylinder body, inner surface of an opening of a caliper body, inward facing surface of a caliper body, a surface of a flange, or any combination thereof. Fastening may include inserting and engaging one or more fasteners in one or more fastener bores, slots, or a combination thereof. Sealing may include applying, curing, inserting, or a combination thereof one or more seals.

The method for forming a caliper housing may further include assembling one or more brake components to the caliper housing. One or more brake components may include one or more brake pads, bushings, brake fluid lines, drive sources, the like, or a combination thereof.

The method may further include assembling a brake system. Assembling a brake system may include assembly of a caliper housing. Assembling a brake system may include connecting the caliper housing to one or more brake lines, drive sources, or both. Assembling a brake system may include mounting a caliper housing to one or more portions of a vehicle. One or more portions of a vehicle may include a knuckle. Assembling a brake system may include locating a rotor within a rotor gap.

### Illustrative Embodiments

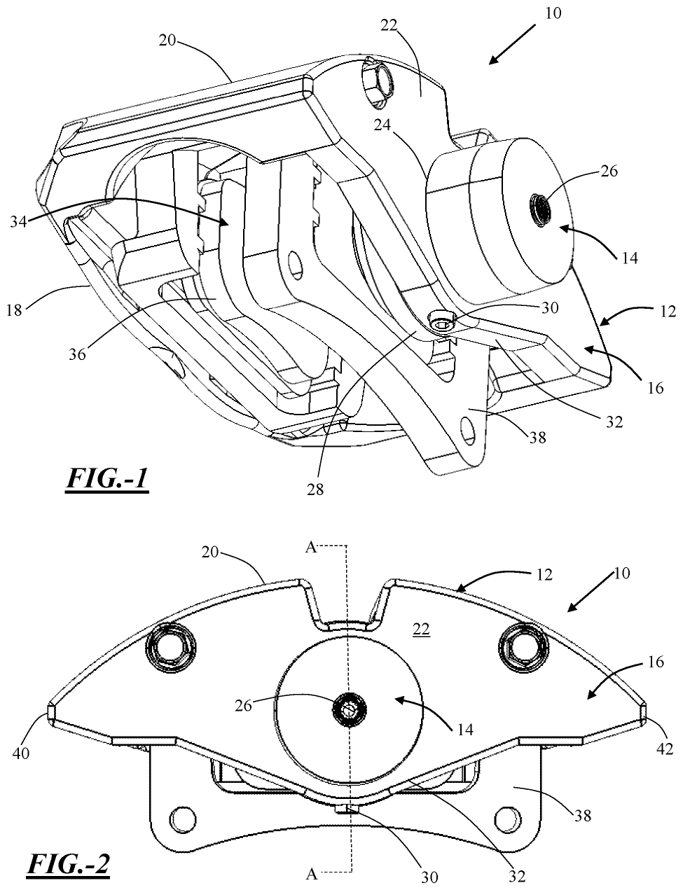

FIG. 1 illustrates a caliper 10. The caliper includes a housing 12. The housing 12 includes a cylinder body 14 assembled to a caliper body 16. The caliper body 16 includes an outboard side 18 integrally connected to a bridge 20. The bridge 20 is integrally connected to an inboard side 22. The caliper body 16 includes an opening 24. The opening 24 extends through the inboard side 22. The opening 24 includes the cylinder body 14 passing therethrough. The cylinder body 14 includes a spindle inlet 26. The cylinder body 14 includes a flange 28. The cylinder body 14 is retained within the opening 24 by a fastener 30. The fastener 30 is located on a surface 32 of the inboard side 22 opposite the bridge 20. The bridge 20 extends over a rotor gap 34. The rotor gap 34 is further defined by an outboard brake pad 36 opposing an inboard brake pad 38.

FIG. 2 illustrates a caliper 10. The caliper includes a housing 12. The housing includes a cylinder body 14 assembled to a caliper body 16. The caliper body 16 includes an inboard side 22. Located within the inboard side 22 is the cylinder body 14. The cylinder body 14 includes a spindle inlet 26. The caliper body 16 includes a leading end 40 opposing a trailing end 42. A fastener 30 extends through a surface 32 of the inboard side 22. An inboard brake pad 38 is protrudes radially inward (e.g., below) from the caliper housing 12.

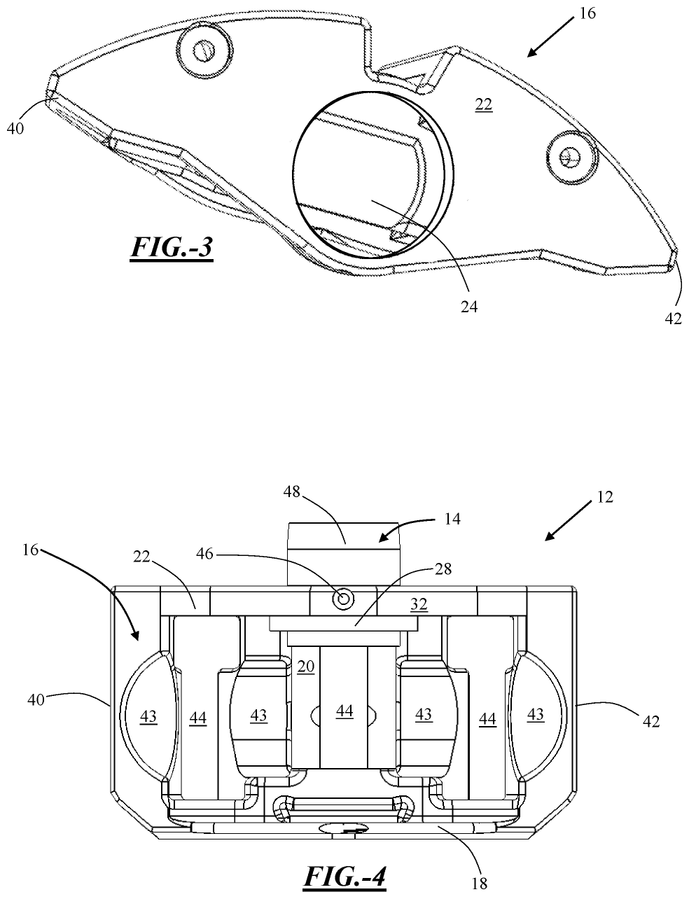

FIG. 3 illustrates a caliper body 16. The caliper body 16 includes an inboard side 22. The inboard side 22 includes an opening 24. The opening 24 is located centrally between the leading and trailing ends 40, 42 of the caliper body 16.

FIG. 4 illustrates a bottom of a caliper housing 12. The caliper housing 12 includes a caliper body 16. The caliper body 16 includes an inboard side 22 opposing an outboard side 18. The inboard side 22 is integrally connected to the outboard side 22 by a bridge 20. The bridge 20 extends from a leading end 40 to a trailing end 42. The bridge 20 includes a plurality of reinforcement structures 43 extending from the inboard side 22 to the outboard side 18. The bridge also includes a plurality of through-holes 44 formed therein and between reinforcement structures 43. The caliper body 16 includes a fastener bore 46. The fastener bore 46 extends through the inboard side 22, from a surface 32 to the opening 24 (not shown). The caliper housing 12 further includes a cylinder body 14. The cylinder body 14 includes a cylindrical wall 48 and flange 28.

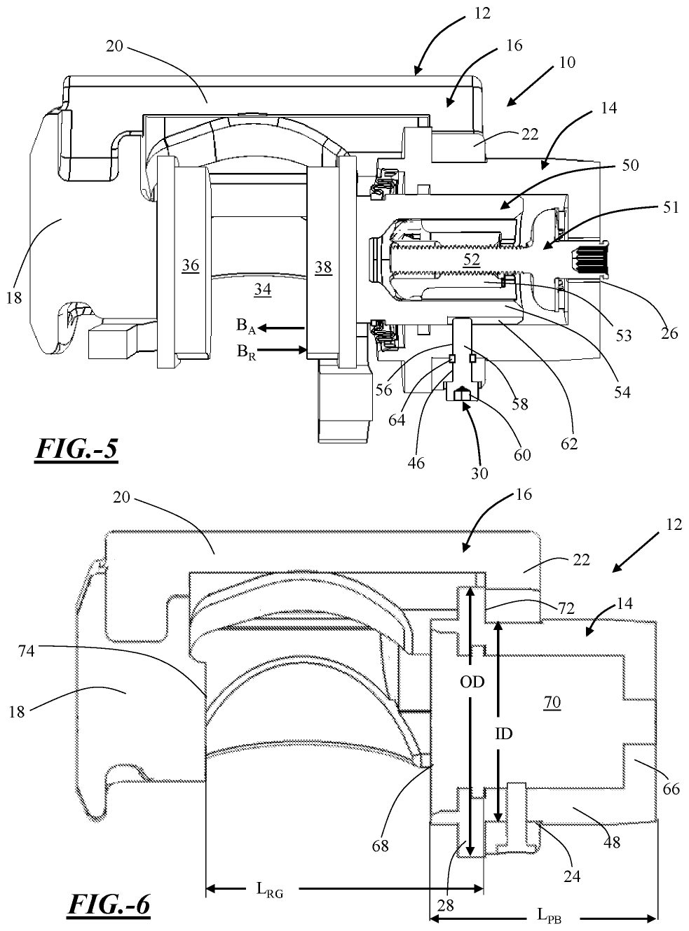

FIG. 5 illustrates a cross-section of a caliper 10 through section A-A of FIG. 2. The caliper 10 includes a caliper body 16. The caliper body 16 includes an inboard side 22 opposing an outboard side 18. Located between the inboard side 22 and the outboard side 18 is a rotor gap 34. Extending over the rotor gap 34 is a bridge 20. Located within the rotor gap 34 is an inboard brake pad 38 opposing an outboard brake pad 36. The inboard brake pad 38 is in contact with a piston 50. The piston 50 includes a piston cylindrical wall 54. The piston 50 includes a linear motion mechanism 51 located partially therein. The linear motion mechanism 51 includes a spindle 52 engaged with a nut 53. The nut 53 is non-moveably affixed relative to an interior of the piston 50. The spindle 52 protrudes through a spindle inlet 26 of the cylinder body 14. The spindle 52 may be in rotatable communication with a drive source (not shown). The piston 50 resides within the cylinder body 14. The fastener bore 46 of the caliper body 16 aligns with a fastener bore 56 in the cylinder body 14. The fastener 30 extends through the inboard side 22 and through the cylinder body 14. Specifically, the fastener 30 extends through both fastener bores 46, 56. The fastener 30 includes a shaft 58 and a head 60. The shaft 58 rests within a slot 62 of the piston cylindrical wall 54. The slot 62 allows the piston 50 to move towards and away from a rotor 102 (not shown) in the rotor gap 34 during a brake apply BA and brake release BR. A seal 64 resides within and between the fastener bores 46, 56.

FIG. 6 illustrates a cross-section of a caliper housing 12 through section A-A of FIG. 2. The caliper housing 12 includes a caliper body 16. The caliper body 16 includes an inboard side 22 opposing an outboard side 18. The inboard side 22 is integrally connected to the outboard side 18 via a bridge 20. The caliper housing 12 includes an opening 24 through the inboard side 22. Within the opening is a cylinder body 14. The cylinder body 14 includes a cylindrical wall 48 having an end wall 66 and an open end 68. The cylindrical wall 48 includes a hollow interior 70 extending from the open end 68 to the end wall 66. The cylinder body 14 includes a flange 28 adjacent to the open end 68. The flange 28 has an outer diameter OD larger than an inner diameter ID of the opening 24. The flange 28 rests on an inward facing surface 72 of the inboard side 22. The inboard side 22 and outboard side 18 are distanced apart with a length L_{RG} greater than a length L_{PB} of the cylinder body 14. The distance between the inward facing surfaces 72, 74 of the inboard side 22 and the outboard side 18 is also the rotor gap 34. The distance between the inboard side 22 and the outboard side 18 is measured as the distance between the inward facing surface 72 of the inboard side 22 and the inward facing surface 74 of the outboard side 18. The length L_{PB} of the cylinder body 14 is measured as the distance from the end wall 66 to the open end 68.

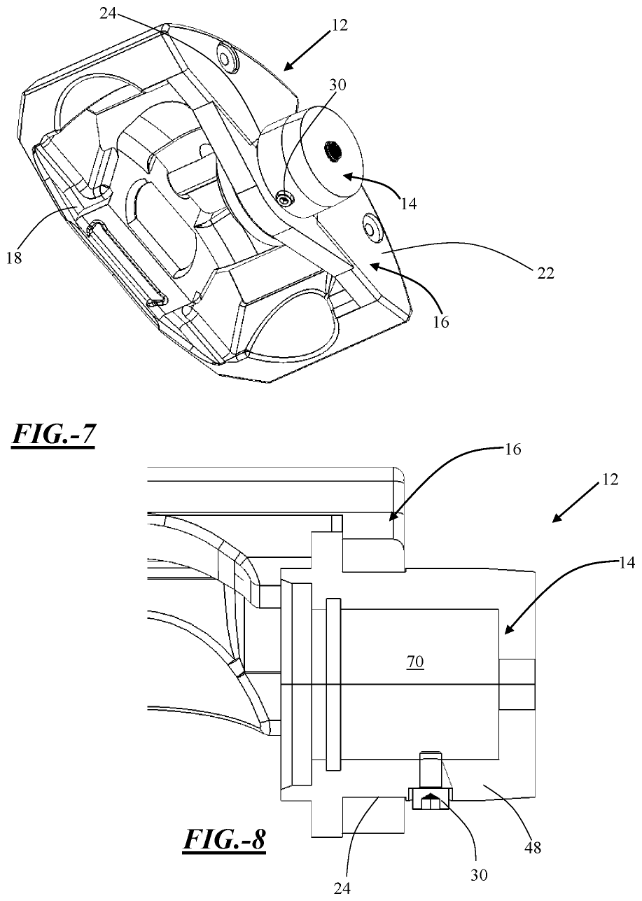

FIGS. 7 and 8 illustrate a caliper housing 12. The caliper housing 12 includes a caliper body 16. The caliper body 16 includes an opening 24. A cylinder body 14 extends through the opening 24. A fastener 30 extends into the cylinder body 14. The fastener 30 extends through the cylindrical wall 48 of the cylinder body 14 into the hollow interior 70. The fastener 30 is located adjacent to an inboard side 22 of the caliper body 16.

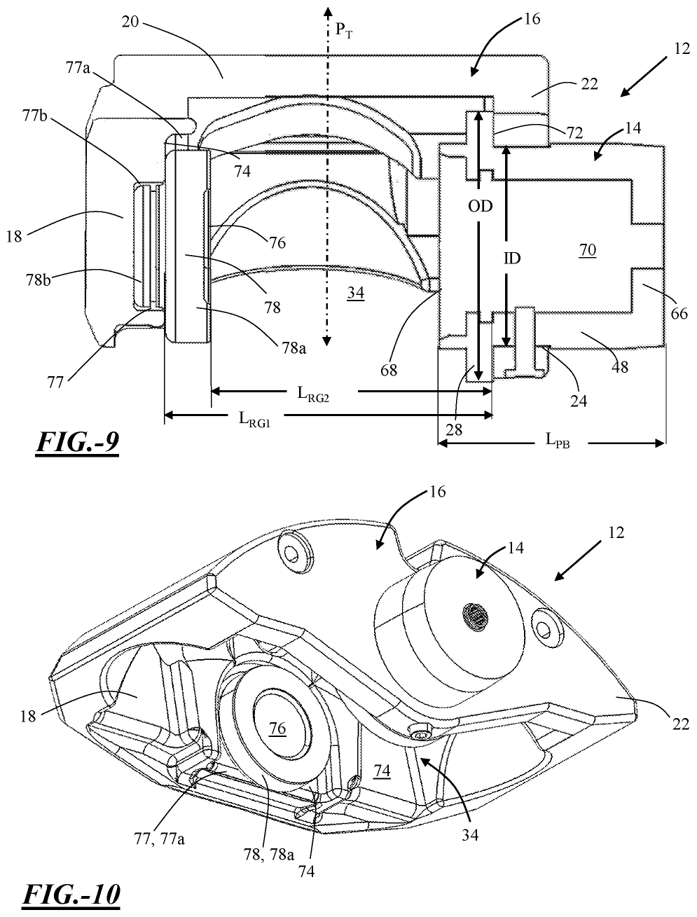

FIG. 9 illustrates a cross-section of a caliper housing 12 through section A-A of FIG. 2. The caliper housing 12 includes a caliper body 16. The caliper body 16 includes an inboard side 22 opposing an outboard side 18. The inboard side 22 is integrally connected to the outboard side 18 via a bridge 20. The caliper housing 12 includes an opening 24 through the inboard side 22. Within the opening 24 is a cylinder body 14. The cylinder body 14 includes a cylindrical wall 48 having an end wall 66 and an open end 68. The cylindrical wall 48 forms a hollow interior 70 extending from the open end 68 to the end wall 66. The cylinder body 14 includes a flange 28 adjacent to the open end 68. The flange 28 has an outer diameter OD larger than an inner diameter ID of the opening 24. The flange 28 rests on an inward facing surface 72 of the inboard side 22. The inward facing surface 72 of the inboard side 22 is opposite an inward facing surface 74 of the outboard side 18. A transverse plane P_{T} is located between and substantially parallel to the inward facing surfaces 72, 74 of the inboard side 22 and outboard side 18. The outboard side 18 includes a recess 77. The recess 77 defines a portion of the inward facing surface 74. The recess 77 includes a first recess portion 77a and a second recess portion 77b. The first recess portion 77a includes a portion of an inward facing surface 74 of the outboard side 18. The recess 77 has gap plate 78 disposed therein. The gap plate 78 includes a first plate portion 78a and a second plate portion 78b. The second plate portion 78b rests within the second recess portion 77b. The first plate portion 78a rests within the first recess portion 77a. The first plate portion 77a includes an inward facing surface 76. The inward facing surface 76 of the gap plate 78 faces toward the inward facing surface 72 of the inboard side 22. The inboard side 22 and outboard side 18 are distanced apart with a length L_{RG2} to form the rotor gap 34. The length L_{RG2} is the distance between the inward facing surface 76 of the gap plate 78 and the inward facing surface 72 of the inboard side 22. The length L_{RG2} may or may not be greater than a length L_{PB} of the cylinder body 14. The rotor gap 34 length is increasable by removing the gap plate 78. Upon removal of the gap plate 78, the inboard side 22 and outboard side 18 are distanced apart with a length L_{RG1}. The length L_{RG1} between the inboard side 22 and outboard side 18 is measured as the distance between the inward facing surface 74 within the first recess portion 77a of the outboard side 18 and the inward facing surface 72 of the inboard side 22.

FIG. 10 illustrates a caliper housing 12. The caliper housing 12 includes a caliper body 16. The caliper body 16 includes an outboard side 18 opposite an inboard side 22. The inboard side 22 includes a cylinder body 14 located therein. The outboard side 18 includes an inward facing surface 74. The inward facing surface 74 faces toward a rotor gap 34 and the inboard side 22. The inward facing surface 74 includes a recess 77 formed therein. The recess 77 includes a first recess portion 77a. The first recess portion 77a includes a portion of the inward facing surface 74. Located within the recess 77 is a gap plate 78. The gap plate 78 includes a first plate portion 78a. The gap plate 78 also includes an inward facing surface 76. The inward facing surface 76 of the gap plate 78 faces toward the rotor gap 34 and the inboard side 22.

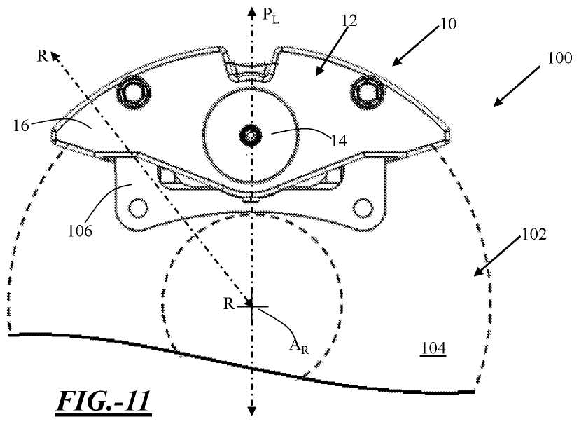

FIG. 11 illustrates a brake assembly 100. The brake assembly 100 includes a caliper 10 and rotor 102. The caliper 10 includes a caliper housing 12. The caliper housing 12 includes a cylinder body 14 attached to a caliper body 16. Located within the caliper housing 12 is an inboard brake pad 106 opposing an outboard brake pad (not shown). Between the inboard brake pad 106 and outboard brake pad is a rotor 102. The rotor 102 includes an inner surface 104 opposing an outer surface (not shown). The rotor 102 rotates about a rotational axis A_{R}. The rotational axis A_{R} defines a radial direction R-R. Radially inward may be the radial direction R-R toward the rotational axis A_{R}. Radially outward may be the radial direction R-R away from the rotation axis A_{R}. The caliper housing 12 has a longitudinal plane P_{L}. The longitudinal plane P_{L} is parallel with and includes the rotational axis lying therein.

Any numerical values recited in the above application include all values from the lower value to the upper value in increments of one unit provided that there is a separation of at least 2 units between any lower value and any higher value. These are only examples of what is specifically intended and all possible combinations of numerical values between the lowest value, and the highest value enumerated are to be considered to be expressly stated in this application in a similar manner. Unless otherwise stated, all ranges include both endpoints and all numbers between the endpoints.

The terms “generally” or “substantially” to describe angular measurements may mean about +/−10° or less, about +/−5° or less, or even about +/−1° or less. The terms “generally” or “substantially” to describe angular measurements may mean about +/−0.01° or greater, about +/−0.1° or greater, or even about +/−0.5° or greater. The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of the elements, ingredients, components, or steps.

Plural elements, ingredients, components, or steps can be provided by a single integrated element, ingredient, component, or step. Alternatively, a single integrated element, ingredient, component, or step might be divided into separate plural elements, ingredients, components, or steps. The disclosure of “a” or “one” to describe an element, ingredient, component, or step is not intended to foreclose additional elements, ingredients, components, or steps.

What is claimed is:

1. A caliper housing comprising:
a) a caliper body including:
i) an inboard side having one or more openings;
ii) an outboard side distanced from the inboard side so that a rotor gap is formed between the inboard side and the outboard side;
iii) a bridge structure which extends from both the inboard side and the outboard side over the rotor gap and connects the inboard side with the outboard side; and
b) one or more cylinder bodies which are hollow, extend through the one or more openings, and are engaged such that the one or more cylinder bodies are non-moveable relative to the one or more openings.

2. The caliper housing of claim 1, wherein the one or more cylinder bodies have a length less than a length of the rotor gap.

3. The caliper housing of claim 1, wherein the one or more cylinder bodies include a flange located within the rotor gap and which abuts with an inward facing surface of the inboard side.

4. The caliper housing of claim 3, wherein the flange has an outer diameter larger than an inner diameter of the one or more openings.

5. The caliper housing of claim 1, wherein the one or more cylinder bodies each include a hollow cylindrical wall having an outer diameter smaller than to about larger than an inner diameter of the one or more openings.

6. The caliper housing of claim 1, wherein the one or more cylinder bodies are press-fit into the one or more openings such that the one or more cylinder bodies are non-moveable relative to the one or more openings.

7. The caliper housing of claim 1, wherein one or more fasteners extend into the one or more cylinder bodies to prevent movement of the one or more cylinder bodies relative to the caliper body.

8. The caliper housing of claim 7, wherein the one or more fasteners extend from the inboard side of the caliper body into the one or more cylinder bodies.

9. The caliper housing of claim 7, wherein the caliper housing is part of a caliper having one or more pistons residing within the one or more cylinder bodies; and
wherein the one or more fasteners reside within one or more slots of the one or more pistons to allow movement of the one or more pistons toward and away from the rotor gap while preventing movement of the one or more cylinder bodies relative to the caliper body.

10. A caliper comprising:
a) a caliper housing including:
i) a caliper body having:
a. an inboard side having one or more openings;
b. an outboard side distanced from the inboard side so that a rotor gap is formed between the inboard side and the outboard side;
c. a bridge structure which extends from both the inboard side and the outboard side over the rotor gap and connects the inboard side with the outboard side; and
ii) one or more cylinder bodies which are hollow, extend through the one or more openings, and are press-fit into the one or more openings such that the one or more cylinder bodies are non-moveable relative to the one or more openings; and
b) one or more pistons residing within the one or more cylinder bodies adapted to move toward and away from the rotor gap to apply and release a brake force.

11. The caliper of claim 10, wherein the one or more cylinder bodies have a length less than a length of the rotor gap.

12. The caliper of claim 10, wherein the one or more cylinder bodies includes a flange located within the rotor gap and which abuts with an inward facing surface of the inboard side; and
wherein the flange has an outer diameter larger than an inner diameter of the one or more openings.

13. The caliper of claim 10, wherein the one or more cylinder bodies each include a hollow cylindrical wall having an outer diameter smaller than to about larger than an inner diameter of the one or more openings.

14. The caliper of claim 10, wherein one or more fasteners extend into the one or more cylinder bodies to prevent movement of the one or more cylinder bodies relative to the caliper body.

15. The caliper of claim 14, wherein the one or more fasteners extend from the inboard side of the caliper body into the one or more cylinder bodies.

16. The caliper housing of claim 15, wherein the one or more fasteners reside within one or more slots of the one or more pistons to allow movement of the one or more pistons toward and away from the rotor gap while preventing movement of the one or more cylinder bodies relative to the caliper body

17. The caliper housing of claim 16, wherein one or more seals are located about the one or more fasteners configured to prevent leakage of a brake fluid from the one or more cylinder bodies, contaminants from entering into the one or more cylinder bodies, or both.

18. A method of assembling a caliper housing comprising:
a) inserting one or more cylinder bodies into a rotor gap of a caliper body, wherein the rotor gap is defined as a distance between an inboard side and an outboard side of the caliper body and are integrally connected via a bridge which extends over the rotor gap;
b) press-fitting the one or more cylinder bodies into one or more openings formed in the inboard side of the caliper body such that a flange of the one or more cylinder bodies abuts with an inward facing surface of the inboard side which faces toward the rotor gap; and
c) securing the one or more cylinder bodies to the caliper body with one or more fasteners.

19. The method of claim 18, wherein the method includes securing the one or more cylinder bodies with one or more fasteners which extend through a cylinder wall of the one or more cylinder bodies.

20. The method of claim 19, wherein the one or more fasteners are located through the inboard side of the caliper body into the one or more cylinder bodies to lock movement of the one or more cylinder bodies relative to the caliper body.
